(19) United States
(12) Patent Application Publication
(10) Pub. No.: US 2022/0234307 A1
(43) Pub. Date: Jul. 28, 2022

(54) FIBER-COMPOSITE PARTS WITH INSERTS AND METHOD FOR INTEGRATION THEREOF

(71) Applicant: Arris Composites Inc., Berkeley, CA (US)

(72) Inventors: Ethan ESCOWITZ, Berkeley, CA (US); Erick DAVIDSON, Piedmont, CA (US); J. Scott PERKINS, Oakland, CA (US); Riley REESE, Oakland, CA (US); Arnaud DYEN, San Francisco, CA (US); Olivier D'AMOURS-ROUSSEAU, Davis, CA (US)

(21) Appl. No.: 17/582,877

(22) Filed: Jan. 24, 2022

Related U.S. Application Data
(60) Provisional application No. 63/140,652, filed on Jan. 22, 2021.

(51) Int. Cl. B29C 70/02; B29C 70/46; F16B 37/12

(52) U.S. Cl. CPC B29C 70/023; B29L 2031/727; F16B 37/122; B29C 70/465

(57) ABSTRACT

A molding method for fabricating a composite part having inserts is provided including disposing preforms in a mold, each having co-aligned, resin-impregnated fibers, placing the inserts in the mold adjacent to at least one of the preforms, wherein each insert has securement features for receiving a portion of the co-aligned resin-impregnated fibers from at least one preform, and applying heat and pressure in an amount sufficient to consolidate the resin-impregnated fibers into a resin matrix, thereby forming the part, including consolidating the fibers and resin within the securement features. A fiber composite part is also provided including continuous, co-aligned fibers within a resin matrix, and at least one insert disposed in the matrix, the insert comprising at least one securement feature having a second plurality of the fibers therein, the second plurality of fibers extending into the resin matrix and overlapping with some of the first plurality of fibers.

### FIELD OF THE INVENTION

The present invention relates to molded materials. More particularly, the present invention is directed to fiber composite parts and methods for fabricating fiber composite parts.

### BACKGROUND

Parts produced via molding processes are advantageous for many reasons, but materials such as plastics and composites are inherently limited in performance relative to metals for certain loading conditions. One example is threaded fasteners, such as nuts, screws, etc. In many applications, plastic threads cannot meet the relevant structural requirements, so metal is typically the preferred material in such cases.

This scenario may present a conflict. That is to say that, although metal might be the preferred material for the threaded attachment, plastic might nevertheless be the preferred material for the remainder of the part. To meet the conflicting needs of such applications, threaded inserts made of metal are often registered within a tool and injection overmolded within a fiber-composite part at appropriate locations in the part. The resultant part is plastic throughout, with metal threads at attachment points. The resultant part exhibits the global benefits of the molding material with the local benefits of a metal insert.

Existing inserts that are molded into parts are typically specific to either injection molding or composite laminate molding. In order to ensure the threaded inserts effectively transfer force to the part and do not pull out of the plastic under load, certain techniques are used. In the case of injection molding, the interfacial surface of the insert is often textured (e.g., knurled, ribbed, baffled, flanged, etc.). Such texture acts to create a mechanical lock between the insert and the surrounding plastic, thus keeping it in place under load. In composite laminate molding, a perforated plate is coupled to and surrounds the inserts. The plate is designed to adhere to the matrix material between laminate plies, thereby bonding the insert to the plies.

None of the inserts described by the prior art are optimized for use in continuous, aligned fiber-composite parts produced using compression molding. For such anisotropic composites, the interaction between an insert and the surrounding material is more complex. The solutions used by the prior art are inefficient at best and ineffective at worst for these anisotropic composites. The art would therefore benefit from a composite part having an insert, and a method that facilitates load transfer between the insert and its anisotropic composite surroundings.

### SUMMARY

The present invention provides a way to efficiently and very effectively achieve load transfer between an insert and anisotropic composites having aligned, continuous fibers.

In accordance with an illustrative embodiment, inserts are tailored to interface with continuous fibers that are present in a composite material. This is in contrast to prior-art inserts, which merely mechanically interlock with surrounding isotropic material (typically chopped fiber in a polymer matrix) or plies of composite material.

Inserts in accordance with the present teachings are physically adapted to receive both “flowed” and “non-flowed” fibers, as appropriate for the achieving a robust interface. Flowed fibers are fibers that, by virtue of their length (relatively small compared to the size of the mold cavity), location in a preform layup/preform charge, and their location within a mold cavity, are capable of flowing from an initial position to a final position. In the present context, the final position would place such fibers in intimate contact with the insert. Non-flowed fibers are those that, by virtue of their length (similar to that of the mold cavity), location in a preform layup/preform charge, and location within a mold cavity, are incapable of flowing.

The physical adaptations of the inserts include macro and micro securement features that facilitate receiving and interlocking the aligned fibers. Both types of securement features may be, for example and without limitation, channels, ridges, baffles, helices, cavities, holes, and protuberances. Additionally, in some embodiments, the securement features are arranged so that a difference in coefficient of thermal expansion (CTE) between the inserts and the composite material can be used to improve the lock achieved by the insert-fiber interaction. In particular, inserts that are co-molded with a part are subjected to the prevailing (elevated) molding temperatures, and will contract more than hoop-oriented fiber during cooling of the mold. With appropriate positioning of fibers relative to the insert, this difference in CTE can be used to place a captive residual load on the insert.

In an exemplary embodiment of the present invention, a compression molding method for fabricating a fiber composite part having at least one insert is provided. The method utilizes a female mold and begins with the step of disposing an assemblage of preforms in the mold, where each preform includes plural, co-aligned, resin-impregnated fibers. The method continues with the step of placing the inserts in the mold adjacent to at least one of the preforms, wherein each insert comprises securement features formed therein. The securement features are for receiving a portion of the co-aligned resin-impregnated fibers from at least one preform. Finally, the method continues with the step of applying heat and pressure in an amount sufficient to consolidate the resin-impregnated fibers into a resin matrix, thereby forming the fiber-composite part, including consolidating the fibers and resin within the securement features of the at least one insert. The inserts are secured in the part by the co-aligned resin-impregnated fibers being disposed within the securement features of the insert.

The step of disposing the assemblage of preforms may include disposing preforms having fibers aligned with anticipated in-use stress vectors in the part. Anisotropy is leveraged by aligning the continuous fibers in the preforms to principal stresses exerted by the insert on the surrounding composite, thus maximizing load transfer effectiveness. By purposefully designing the insert's geometry in regards to its anisotropic surroundings, it can transfer stress more effectively than in the prior art. This is accomplished by specific features of the insert that interface with relevant fibers. Such insert features fall into two categories—(I) those which preforms are placed into and (II) those which fibers are flowed into. Typically, type (I) insert features are typically the aforementioned macro-securement features, and type (II) insert features are typically the aforementioned micro-securement features.

In some embodiments, the macro securement feature, such as channels (and hence the preforms within), are designed to be aligned with high-magnitude principal stress vectors that are anticipated to be present across the insert's outer surfaces. Unlike the interlocking features of existing inserts, stress transferred by the channel is in alignment with proximal fibers, thus maximizing effectiveness through anisotropy.

The step of applying heat and pressure including consolidating fibers and resin within the securement features (in accordance with compression molding protocols) may include flowing of fibers and resin into the securement feature, capturing fibers and resin within the securement feature, or both. The insert may have at least one securement feature that is a cavity. The securement features may have a plurality of micro-orifices (a micro-securement feature), where each micro-orifice receives at least one fiber. Here, the step of applying heat and pressure may include flowing the at least one fiber into each micro-orifice. The micro-orifices may have a diameter of at least an order of magnitude greater in size than the fibers. The inserts may have a different coefficient of thermal expansion than that of the resin-impregnated fibers, and wherein the step of applying heat and pressure causes the resin-impregnated fibers to expand and contract at a different rate than the insert. The resin may be, for example, thermoplastic. The insert may be constructed from a non-composite-material. The non-composite material may be for example, metal, ceramic, or another resin or composite having a higher melt temperature than that of the resin (for example, PEEK). The inserts may be a fastener or a portion thereof, such as a threaded fastener.

In accordance with embodiments of the invention, heat and pressure are applied in accordance with compression molding protocols. In particular, compression molding involves the application of heat and pressure to feed constituents for a period of time. For applicant's processes, the applied pressure is usually in the range of about 500 psi to about 3000 psi, and temperature, which is a function of the particular resin being used, is typically in the range of about 150° C. to about 400° C. Once the applied heat has increased the temperature of the resin above its melt temperature, it is no longer solid. The resin will then conform to the mold geometry via the applied pressure. Elevated pressure and temperature are typically maintained for a few minutes. Thereafter, the mold is removed from the source of pressure and is cooled. Once cooled, the finished part is removed from the mold.

A fiber composite part is also provided, including a plurality of continuous, co-aligned fibers within a resin matrix, and at least one insert disposed in the resin matrix, the insert having at least one securement feature having a second plurality of the fibers therein, the second plurality of fibers extending into the resin matrix and overlapping with some of the first plurality of fibers.

The securement features may include at least one macro security feature of a similar size to a diameter of towpreg used in the fabrication of the part. A plurality of micro security features may be disposed in at least one of the macro security features where the micro security features receive the second plurality of fibers. At least one of the securement features may include at least one vent. The securement features may be, for example, baffles, helices, cavities, holes, and channels. The inserts may have a different coefficient of thermal expansion than that of the resin matrix and the first plurality of fibers. The resin may be thermoplastic. The insert may be constructed from a non-composite-material, for example, metal, ceramic, or another resin or composite having a higher melt temperature than that of the resin. The inserts may be a fastener or a portion thereof, for example, a threaded fastener or a portion thereof.

Summarizing, a method, as depicted and described, comprises: (i) disposing an assemblage of preforms in a mold cavity, (ii) placing at least one insert in the mold adjacent to at least one of the preforms, wherein the insert has a securement feature formed therein, (iii) applying heat and pressure to consolidate the fibers into a resin matrix to form the part, including consolidating fibers within the securement feature. And a fiber composite part, as depicted and described, comprises: (a) a first plurality of continuous, co-aligned fibers within a resin matrix, and (b) at least one insert disposed in the resin matrix, the insert comprising at least one securement feature having a second plurality of the fibers therein, the second plurality of fibers extending into the resin matrix and overlapping with some of the first plurality of fibers. Embodiments of the method and fiber composite part may further comprise at least one of the following steps or features, in any (non-conflicting) combination, among others disclosed herein:
the securement feature is a macro-securement feature;
the securement feature is a micro-securement feature;
the macro-securement feature aligns with an anticipated principal stress vector in the part proximate to the insert.
preforms are placed in the macro-securement feature;
fibers are flowed into the micro-securement feature;
securement features are vented;
the insert has a different coefficient of thermal expansion than that of the resin matrix;
the insert is a non-composite material;
the insert is a composite material having a higher melting point than the resin in the preforms;
the insert is a fastener;
fibers within the securement feature overlap with fibers disposed in other regions of the fiber-composite part;
flowing of fibers and resin into the securement feature, and capturing the flowed fibers therein;
the insert includes features, such as serrations and grooves, that are positioned to resist both torsion and out-of-plane moment loads, based on the orientation of the insert within the part;
the applied pressure during consolidation is greater than 1000 psig;
the preforms have a circular cross section;
the preforms are non-linear;
the insert includes at least one macro-securement feature and at least one micro-securement feature;
the insert is integrated into an anisotropic part.

### BRIEF DESCRIPTION OF THE DRAWINGS

FIG. 1A is a simplified isometric view of an exemplary insert for use in a fiber composite part and a compression molding method for fabricating a fiber composite part in accordance with an exemplary embodiment of the present invention, where the insert includes a macro securement feature for receiving non-flowed fibers.

FIG. 1B is a simplified isometric view of an exemplary insert for use in a fiber composite part and a compression molding method for fabricating a fiber composite part in accordance with another exemplary embodiment of the present invention, where the insert includes macro and micro securement features for receiving flowed fibers.

FIG. 1C is a simplified cross sectional, elevation detail view of the insert of FIG. 1B, taken at callout A of FIG. 1B.

FIG. 2A is a simplified isometric view a fiber composite part in accordance with another exemplary embodiment of the present invention, having an insert disposed within the part, wherein the insert is adapted to receive both flowed and non-flowed fibers.

FIG. 2B is a simplified isometric view of the insert of FIG. 2A.

FIG. 2C is a simplified isometric view of the insert of FIG. 2A, shown with several fibers of the part to illustrate the interaction between fibers and insert.

FIG. 3A is a simplified isometric view of an alternate fiber composite part in accordance with another exemplary embodiment of the present invention, having an insert disposed within the part, wherein the insert is adapted to receive both flowed and non-flowed fibers.

FIG. 3B is a simplified isometric view of the insert of FIG. 3A.

FIG. 3C is a simplified isometric view of the insert of FIG. 3A, shown with several fibers of the part to illustrate the interaction between fibers and insert.

FIG. 4A is a simplified isometric view of another alternate fiber composite part in accordance with another exemplary embodiment of the present invention, having an insert disposed within the part, wherein the insert is adapted to receive both flowed and non-flowed fibers.

FIG. 4B is a simplified isometric view of an insert of FIG. 4A, shown with several fibers of the part to illustrate the interaction between fibers and insert.

FIG. 5A is a simplified isometric view of another alternate fiber composite part in accordance with another exemplary embodiment of the present invention, having an insert disposed within the part, wherein the insert is adapted to receive both flowed and non-flowed fibers.

FIG. 5B is a simplified isometric view of the insert of FIG. 5A.

FIG. 5C is a simplified isometric view of the insert of FIG. 5A, shown with several fibers of the part to illustrate the interaction between fibers and insert.

FIG. 6A depicts an alternative view embodiment of an insert that promotes the overlap of fibers via alternating flow dams.

FIG. 6B depicts further detail of the insert of FIG. 6A

FIG. 6C is an isometric view of the insert of FIG. 6A, shown with several fibers of the part to illustrate the interaction between fibers and insert.

### DETAILED DESCRIPTION

The following terms, and their inflected forms, are defined for use in this disclosure and the appended claims as follows:
“Fiber” means an individual strand of material. A fiber has a length that is much greater than its diameter. A fiber may be classified as being “continuous.” Continuous fibers have a length that is no less than about 60 percent of the length of a mold feature or part feature where they will ultimately reside. Hence, the descriptor “continuous” pertains to the relationship between the length of a fiber and a length of a region in a mold or part in which the fiber is to be sited. For example, if the long axis of a mold has a length of 100 millimeters (mm), fibers having a length of about 60 mm or more would be considered “continuous fibers” for that mold. A fiber having a length of 20 mm, if intended to reside along the same long axis of the mold, would not be “continuous.” Such fibers are referred to herein as “short fibers.” Short fiber, as the term is used herein, is distinct from “chopped fiber,” as that term is typically used in the art. In the context of the present disclosure, all fibers, regardless of length, will be sourced from preforms. And substantially all of the (typically thousands of) fibers in a preform are co-aligned. As such, all fibers, regardless of length and regardless of characterization as “continuous” or otherwise, will have a defined orientation in the preform layup or preform charge in the mold and in the final part. Chopped fiber, as that term is used in the art, refers to fibers that, in addition to being short, have a random orientation in a mold and the final part.
“Fiber bundle” means plural (typically multiples of one thousand) co-aligned fibers.
“Tow” means a bundle of unidirectional fibers, (“fiber bundle” and “tow” are used interchangeably herein unless otherwise specified). Tows are typically available with fibers numbering in the thousands: a 1K tow (1000 fibers), 4K tow (4000 fibers), 8K tow (8000 fibers), etc.
“Prepreg” means fibers, in any form (e.g., tow, woven fabric, tape, etc.), which are impregnated with resin.
“Towpreg” or “Prepreg Tow” means a fiber bundle (i.e., a tow) that is impregnated with resin.
“Preform” means a segment of plural, co-aligned, resin-impregnated fibers. The segment has been cut to a specific length, and, in many cases, will be shaped (e.g., bent, twisted, etc.) to a specific form, as appropriate for the specific part being molded. Preforms are usually sourced from towpreg (i.e., the towpreg is sectioned to a desired length), but can also be from another source of plural co-aligned fibers (e.g., from a resin impregnation process, etc.). The cross section of the preform, and the fiber bundle from which it is sourced, typically has an aspect ratio (width-to-thickness) of between about 0.25 to about 6, and more typically has an aspect ratio close to 1.0 and a circular cross section. Nearly all fibers in a given preform have the same length (i.e., the length of the preform) and, as previously noted, are co-aligned. The modifier “fiber-bundle-based” or “aligned fiber” is often pre-pended, herein, to the word “preform” to emphasize the nature of applicant's preforms and to distinguish them from prior-art preforms, which are typically in the form of tape, sheets, or shapes cut from sheets of fiber. Applicant's use of the term “preform” explicitly excludes any size of shaped pieces of: (i) tape (typically having an aspect ratio, as defined above, of between about 10 to about 30), (ii) sheets of fiber, and (iii) laminates. Regardless of their ultimate shape/configuration, these prior-art versions of preforms do not provide an ability to control fiber alignment in a part in the manner of applicant's fiber-bundle-based preforms.
“Consolidation” means, in the molding/forming arts, that in a grouping of fibers/resin, void space is removed to the extent possible and as is acceptable for a final part. This usually requires significantly elevated pressure, either through the use of gas pressurization (or vacuum), or the mechanical application of force (e.g., rollers, etc.), and elevated temperature (to soften/melt the resin).
“Partial consolidation” means, in the molding/forming arts, that in a grouping of fibers/resin, void space is not removed to the extent required for a final part. As an approximation, one to two orders of magnitude more pressure is required for full consolidation versus partial consolidation. As a further very rough generalization, to consolidate fiber composite material to about 80 percent of full consolidation requires only 20 percent of the pressure required to obtain full consolidation.
“Preform Charge” means an assemblage of (fiber-bundle-based/aligned fiber) preforms that are at least loosely bound together (“tacked”) so as to maintain their position relative to one another. Preform charges can contain a minor amount of fiber in form factors other than fiber bundles, and can contain various inserts, passive or active. As compared to a final part, in which fibers/resin are fully consolidated, in a preform charge, the hybrid/preforms are only partially consolidated (lacking sufficient pressure and possibly even sufficient temperature for full consolidation). By way of example, whereas applicant's compression-molding processes is typically conducted at about 1000-3000 psi (which will typically be the destination for a preform charge in accordance with the present teachings), the downward pressure applied to the preforms to create a preform charge in accordance with the present teachings is typically in the range of about 10 psi to about 100 psi. Thus, voids remain in a preform charge, and, as such, the preform charge cannot be used as a finished part.
“Preform Layup” means an arrangement of individual preforms that are placed in a mold cavity. A preform layup is distinguished from a preform charge, wherein, for the latter, the preforms are at least loosely bound to one another.
“Compatible” means, when used to refer to two different resin materials, that the two resins will mix and bond with one another.
“Stiffness” means resistance to bending, as measured by Young's modulus.
“Tensile strength” means the maximum stress that a material can withstand while it is being stretched/pulled before “necking” or otherwise failing (in the case of brittle materials).
“About” or “Substantially” means+/−20% with respect to a stated figure or nominal value.

Embodiments of the inventions provide a way to incorporate, during compression molding, a typically non-composite-material (e.g., metal, ceramic, etc.) insert into a fiber-composite part. In accordance with the illustrative embodiment, the inserts interface with fibers that are present in the fiber-composite part.

Feed Constituents. In the exemplary embodiments of the invention as discussed herein, the fibers from the fiber-composite part are sourced from fiber-bundle-based preforms. Each such fiber-bundle-based preform is a segment of plural, co-aligned resin-impregnated fibers. The segments are typically sourced from towpreg, but such bundles may also be sourced from the output of a resin impregnation line. For convenience, the term “fiber bundle” is used hereinafter to refer to both towpreg or the output of a resin impregnation line. Each fiber bundle includes thousands of unidirectionally aligned, resin-infused fibers, typically in multiples of one thousand (e.g., 1 k, 10 k, 24 k, etc.). The fiber bundle may have any suitable cross-sectional shape (e.g., circular, oval, trilobal, polygonal, etc.), but is typically more or less circular.

Applicant uses such fiber-bundle-based preforms for fiber-composite processing, to the extent possible, since they provide an unprecedented ability to align fibers in a finished part with the anticipated stress vectors therein, based on expected in-use loading conditions for the part. Such alignment results in superior part mechanical properties.

The individual fibers in the fiber bundles can have any diameter, which is typically, but not necessarily, in a range of 1 to 100 microns. Individual fibers can include an exterior coating such as, without limitation, sizing, to facilitate processing, adhesion of binder, minimize self-adhesion of fibers, or impart certain characteristics (e.g., electrical conductivity, etc.).

Each individual fiber can be formed of a single material or multiple materials (such as from the materials listed below), or can itself be a composite. For example, an individual fiber can comprise a core (of a first material) that is coated with a second material, such as an electrically conductive material, an electrically insulating material, a thermally conductive material, or a thermally insulating material.

In terms of composition, each individual fiber can be, for example and without limitation, carbon, glass, natural fibers, aramid, boron, metal, ceramic, polymer filaments, and others. Non-limiting examples of metal fibers include steel, titanium, tungsten, aluminum, gold, silver, alloys of any of the foregoing, and shape-memory alloys. “Ceramic” refers to all inorganic and non-metallic materials. Non-limiting examples of ceramic fiber include glass (e.g., S-glass, E-glass, AR-glass, etc.), quartz, metal oxide (e.g., alumina), alumina silicate, calcium silicate, rock wool, boron nitride, silicon carbide, and combinations of any of the foregoing. Furthermore, carbon nanotubes can be used.

Any thermoplastic resin that bonds to itself under heat and/or pressure can be used. Exemplary thermoplastic resins useful in conjunction with embodiments of the invention include, without limitation, acrylonitrile butadiene styrene (ABS), nylon, polyaryletherketones (PAEK), polybutylene terephthalate (PBT), polycarbonates (PC), and polycarbonate-ABS (PC-ABS), polyetheretherketone (PEEK), polyetherimide (PEI), polyether sulfones (PES), polyethylene (PE), polyethylene terephthalate (PET), polyphenylene sulfide (PPS), polyphenylsulfone (PPSU), polyphosphoric acid (PPA), polypropylene (PP), polysulfone (PSU), polyurethane (PU), polyvinyl chloride (PVC).

To mold a fiber composite part via compression molding, preforms may be added one-by-one to a mold cavity, forming a “lay-up.” For a variety of reasons (most notably for both process efficiency as well a substantially greater likelihood that the desired preform alignment is maintained), in some embodiments, rather than adding preforms individually to a mold, the preforms are grouped and tacked together prior to placement in a mold, and then placed in the mold cavity en masse, as a preform charge. The preform charge is typically a three-dimensional arrangement of preforms, which is usually created in a fixture separate from the mold, and which is dedicated and specifically designed for that purpose. To create a preform charge, preforms are placed (either automatically or by hand) in a preform-charge fixture. By virtue of the configuration of the fixture, the preforms are organized into a specific geometry and then bound together. The shape of the preform charge usually mirrors that of the intended part, or a portion of it, and, hence, the mold cavity (or at least a portion thereof) that forms the part. See, e.g., U.S. Pat. Publ. Nos. US2020/0114596 and US2020/0361122, incorporated herein by reference.

Although only partially consolidated, the preforms in the preform charge will not move, thereby maintaining the desired geometry and the specific alignment of each preform in the assemblage. This is important for creating a desired fiber alignment in the mold, and, hence, in the final part.

Thus, for use in conjunction with embodiments of the present invention, preforms, as well as other feed constituents, may be organized as a “layup,” a “preform charge,” or both, as suits the particular embodiment. As used in this disclosure and the appended claims, the term “assemblage of preforms” means either a “preform charge” or a “layup” of preforms, unless otherwise indicated.

Insert Integration. In the prior art, inserts that are to be integrated into composite materials are typically designed to interface with isotropic material at any general location within a part. Some prior art inserts are designed to integrate within a laminate ply layup, which is not isotropic. In contrast, inserts described herein leverage applicant's fiber-alignment capabilities in a design-specific manner. The interplay between design of the insert and fiber alignment can improve part performance by means of part-to-insert load transfer effectiveness, and vice versa.

The inserts disclosed herein, and the physical adaptations which they incorporate, are purposefully designed for integration with (aligned) continuous fiber composites. Anisotropy is leveraged by aligning continuous fibers to principal stresses exerted by the insert on the surrounding composite, thus maximizing load transfer effectiveness. By purposefully designing the insert's geometry in regards to its anisotropic surroundings, it can transfer stress more effectively than the prior art. This is accomplished by specific securement features of the insert that interface with relevant fibers. It is noted that not all fibers in the part need be co-aligned. In the method of the present invention, fibers are preferably aligned with the stress vectors throughout the part, based on the loads they experience in use. The direction of the stress will vary throughout the part, based on the loading conditions, and the geometry of the part.

Such insert securement features fall into two categories: (I) securement features in which preforms are placed, and (II) securement features into which fibers are flowed.

With respect to category (I), the loads exerted on the insert determine the principal stress vectors that are present across its surface. Those loads are transferred, to the extent possible, to the surrounding composite. In some embodiments, channels (a macro securement feature) are formed in the insert. Such channels are aligned with the high-magnitude principal stress vectors that will be present, in use of the part, across the insert's outer surfaces. Fiber-bundle-based preforms are stacked into such channels during the layup process. (Or a pre-assembled “preform charge” designed to fit in such channels is formed and then placed in the channel.) In similar fashion, an assemblage consisting of one or more inserts, and surrounding fiber-bundle-based preforms (either individually laid up or preassembled as a preform charge) are placed in a mold cavity so that, during compression molding, the insert(s) and fibers from the fiber-bundle-based preforms will interconnect as desired. Alternatively, a ridge, as opposed to a groove/channel could be used.

Analogous to the holes of a button accommodating threads, preforms placed into the channels in the insert result in aligned, continuous fibers fastening the insert within the molded part. Unlike the interlocking features of prior-art inserts, stress transferred by the channel is in alignment with local fibers, thus ensuring more effective stress transfer through anisotropy.

Securement features into which fibers are flowed differ from earlier art developed by the applicant in that they act to interlock an insert to a part, as opposed to coupling a volumetric region of a part to its global volume. The securement features themselves are described by the present invention, whereas the flowing of fibers is disclosed in other of applicant's patent publications, such U.S. Pat. Nos. 10,926,489, 10,946,595, 11,192,314, and 11,225,035, all of which are incorporated by reference herein.

Such publications disclose the flowing of fibers into features of a mold via a pressure gradient. In conjunction with the present invention, fibers are flowed into features of an insert via the same mechanism. Fibers flowed into insert features overlap adjacent continuous fibers to transfer stress thereto. The features of the insert into which fibers flow can generally be described as “macro” and “micro.”

The typical size of macro securement features may be similar (e.g., to that of the diameter of the constituent towpreg (e.g., the same order of magnitude) from which the preforms are formed. However, macro features could also be, for example, an order of magnitude greater or more than the constituent towpreg. From a process efficiency standpoint, it is more efficient to flow fibers into such securement features than to bend preforms (during fabrication) to match the shape of such macro securement features and place such bent preforms therein. Preforms having fibers that are intended to flow (“flow-segment preforms”) are placed accordingly in the layup (proximal to the macro securement feature with which they are intended to interface) to repeatedly facilitate flow into the macro securement feature.

For example, baffles, helices, cavities, holes, and or channels may be positioned across an insert in a given embodiment such that fibers that flow into them during molding will be aligned to principal stress vectors in the resultant part. In a particular embodiment, an insert channel may have fibers flowed into it, whereas a channel of the same geometry may have preforms placed into it in a separate embodiment. Determination of whether fibers ought to be flowed, on the one hand, or placed in the macro securement feature on the other hand, is application dependent.

Micro securement features are approximately an order of magnitude less in size than constituent towpreg diameter, the latter having a typical diameter of about 1.5 mm. Whereas a single macro securement feature may interlock a multitude of aligned fibers, the same multitude of fibers would typically be distributed across many micro securement features. In a sense, such micro securement features enable load transfer through quantity rather than quality, analogous to Velcro®. Micro securement features generally take the form of a textured surface relief pattern, and may or may not have venting features at their terminal depth. Flow segment preforms are placed proximally to micro securement features in the preform layup.

### Exemplary Embodiments

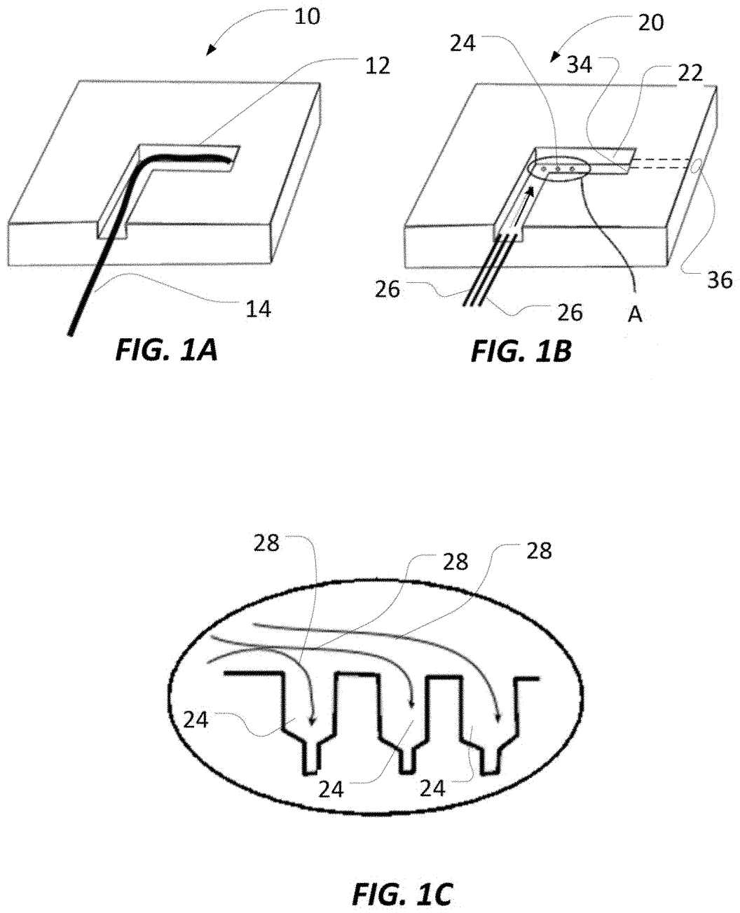

Referring now to the drawing figures wherein like part numbers refer to like elements throughout the several views, there is shown in FIGS. 1A and 1B examples of two different inserts for use in the composite part and the method of the present invention. FIG. 1A depicts a simplified view of an insert 10 for use in an exemplary embodiment of the fiber composite part and the compression molding method for fabricating a fiber composite part of the present invention, shown laid up with an aligned fiber preform 14 of resin-impregnated fibers. Here, the insert 10 includes an L-shaped macro securement feature 12 (e.g., a cavity) for receiving the aligned fiber preform 14, where the fibers in the preform 14 are non-flowed fibers. Adjacent preforms residing in the securement feature 12 and proximal to the insert 10 are omitted for clarity. The compression-molding process forms the proximal preforms to the shape of the insert 10, thus interlocking the insert 10 within its molded part via aligned, continuous fibers.

FIG. 1B depicts a simplified view of another insert 20 for use in the fiber composite part and the compression molding method for fabricating a fiber composite part of an exemplary embodiment of the present invention. Here, the insert 20 also includes an L-shaped macro securement feature 22, as well as micro securement features 24. FIG. 1C is a simplified cross-sectional view of a portion of the insert 20 of FIG. 1B, taken at callout A of FIG. 1B. This view depicts the addition of the micro securement features 24 incorporated into the macro securement feature 22, where the macro securement feature 22 receives preforms 26 having fibers 28 (see FIG. 1C discussed below) that flow in to the securement feature 22. The preforms 26 are laid up proximally to the inlet 30 of the macro securement feature 22 in the insert 20. The micro securement features 24 each receive at least one fiber 28. FIG. 1C depicts flow paths of fibers 28 into the micro securement features 24 of the insert 20. A small terminal cavity 32 is disposed in each micro securement feature 24 for air capture. During compression molding, the resultant pressure gradient will drive the material into the macro securement features 22 and micro securement features 24 of the insert 20. The terminal end 34 of the macro securement feature 22 may have a vent 36 to create a pressure differential that enables fiber/resin to freely flow into the micro securement feature 24 and prevent trapping air.

In both of the embodiments of FIGS. 1A and 1B, the ‘L’ shape macro securement feature 12, 22 of each insert 10, 20 is designed such that fibers within the securement feature 12, 22 in the resultant molded part will be oriented, to the extent possible, to optimally withstand the applied load. Specification of one embodiment versus the other is determined by the relevant application and associated manufacturing constraints.

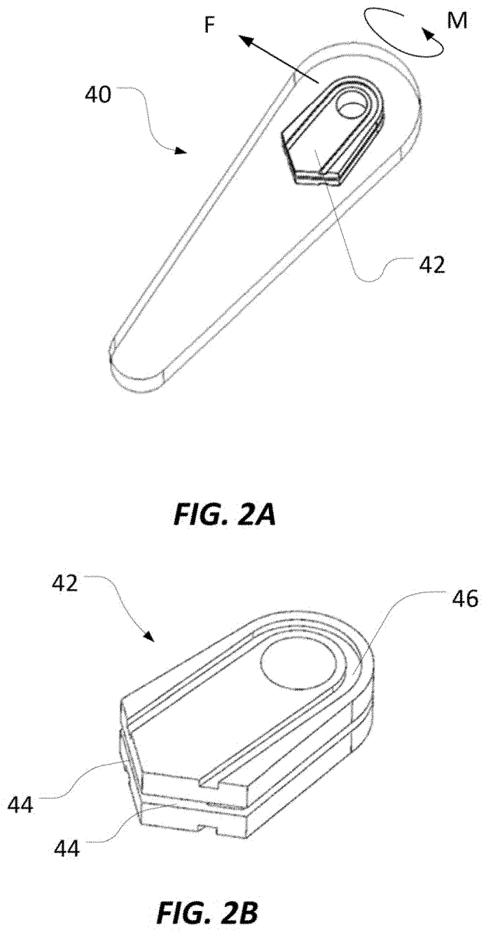

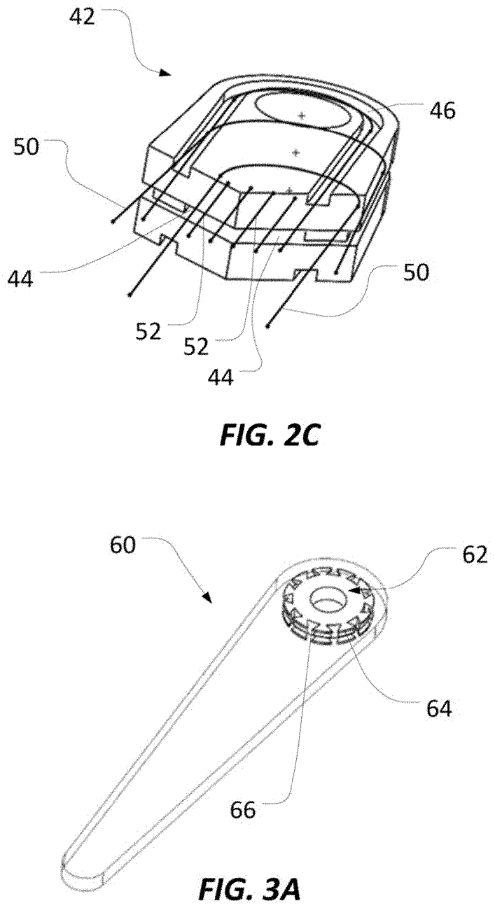

FIG. 2A depicts a fiber composite part 40 in accordance with an exemplary embodiment of the present invention. The part 40 has an insert 42 (see FIG. 2B) disposed within the part 40, where the insert 42 is adapted to receive both flowed and non-flowed fibers. For the present example, the part 40 is a bicycle crank arm where the insert is for receipt of a pedal. During pedaling, a force F and a moment M are experienced by the insert 42.

To maximally withstand these loads through anisotropy, the insert 40 possesses macro securement features 46 for non-flowed fibers and macro securement features 44 for flowed fibers (see FIG. 2B) which interface with continuous fibers of preforms 50, 52. Other preforms within the layup are omitted for clarity.

FIG. 2C depicts the insert 42 and preforms 50 that have continuous fibers that interface with macro-securement features 44, 46 (e.g., channels or grooves) formed in the insert 42. FIG. 2C also depicts flow-segment preforms 52 that are positioned proximal to a macro securement feature 44 (e.g., a cavity) formed in the insert. Fibers from the flow-segment preforms 52 will flow into the cavity, wherein each of such flowed fibers will have a portion that is within the macro securement feature 44, and a portion that extends into the matrix of the surrounding part. Each respective preform 50, 52 type has been omitted in the companion figure for clarity.

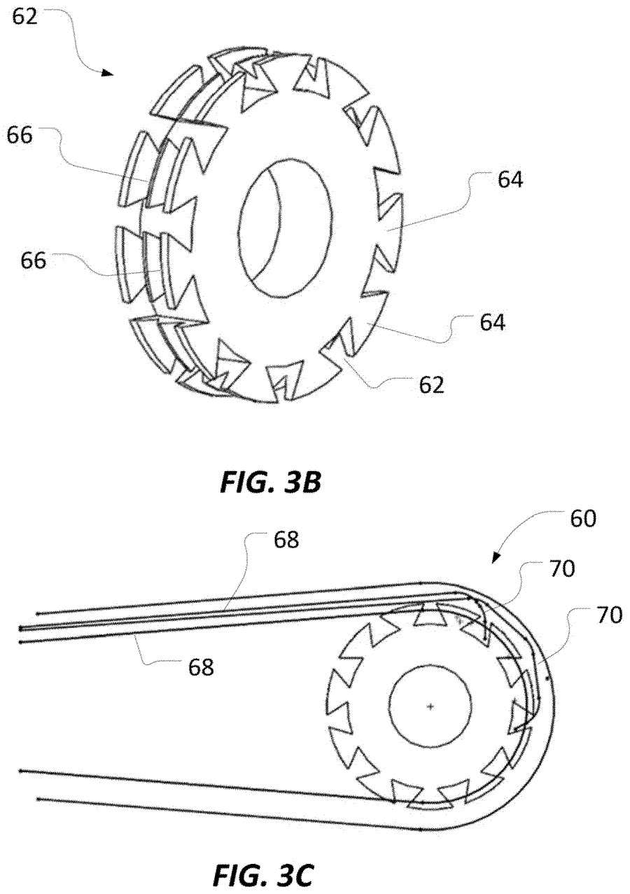

FIG. 3A depicts a fiber composite part 60 in accordance with another exemplary embodiment of the present invention. The part 60 has an insert 62 (see FIG. 3B) disposed therein, where the insert 62 is adapted to receive both flowed and non-flowed fibers. The insert 62 has serrations 64 and grooves 66, which, in combination, are designed to resist both torsion and out-of-plane moment loads. As can be seen in FIG. 3C, flowed fibers 68 flow into the V-shaped serrations 66 and fibers 70 fill around the insert 62 in the hoop (tangential) direction. Fibers will also bulge out during filling to fill in the dovetail gaps 72 between serrations 66.

Due to differences in material properties, as the part 60 cools, the material of the co-molded insert 62 may be selected to shrink at a faster rate than the hoop-oriented fibers 68, 70 and the outer V-shaped serrations 66 will compress and lock in the some of the fibers 70 in the serrations 66. The V-shaped serrations 66 support a torsion load and the grooves 66 support an out-of-plane moment. Note that although the insert 62 is depicted as circular, this doesn't necessarily have to be the case. Notably, for example, a hexagonal or square lug can better support torsional loads.

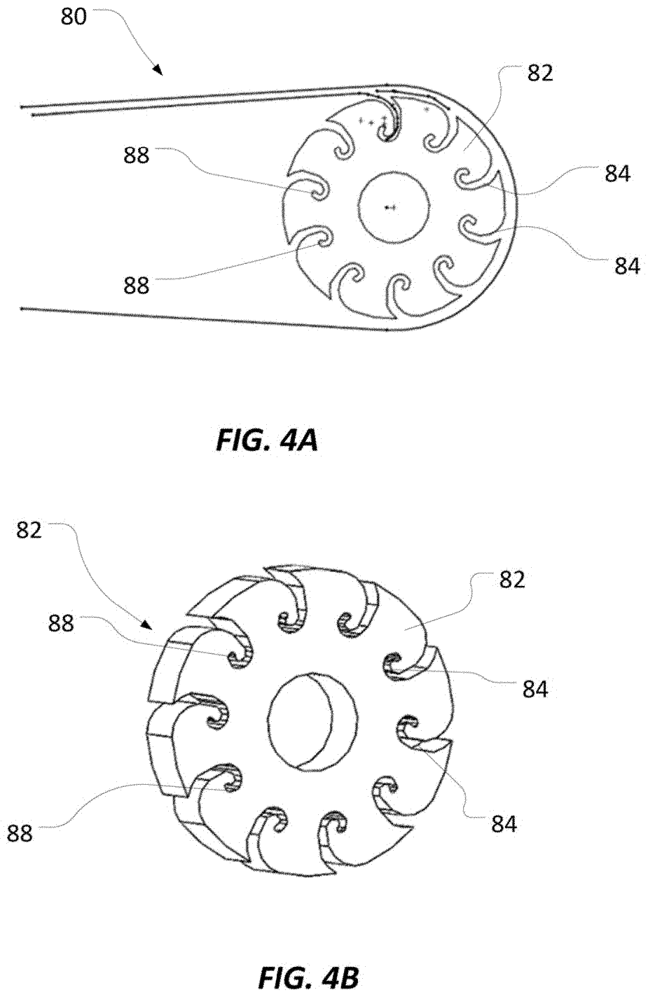

In FIGS. 4A and 4B, a part 80 having an insert 82 with radially oriented “hook” securement features 84 is depicted in accordance with another alternative embodiment of the present invention. During co-molding of this insert 82 in the part 80, fibers 86 flow into the hooks 84, each of which hooks 84 preferably being vented (not shown) at the terminal end 88 thereof. The hook securement features 84 are used to trap fiber 86 with contraction of the (for example, metal) lug during mold cooling due to differences in the coefficients of thermal expansion of the materials. Each hook securement feature 84 has a smooth lead-in to promote fiber engagement. This embodiment represents a more aggressive form of fiber entrapment. This lug would also support a torsional load.

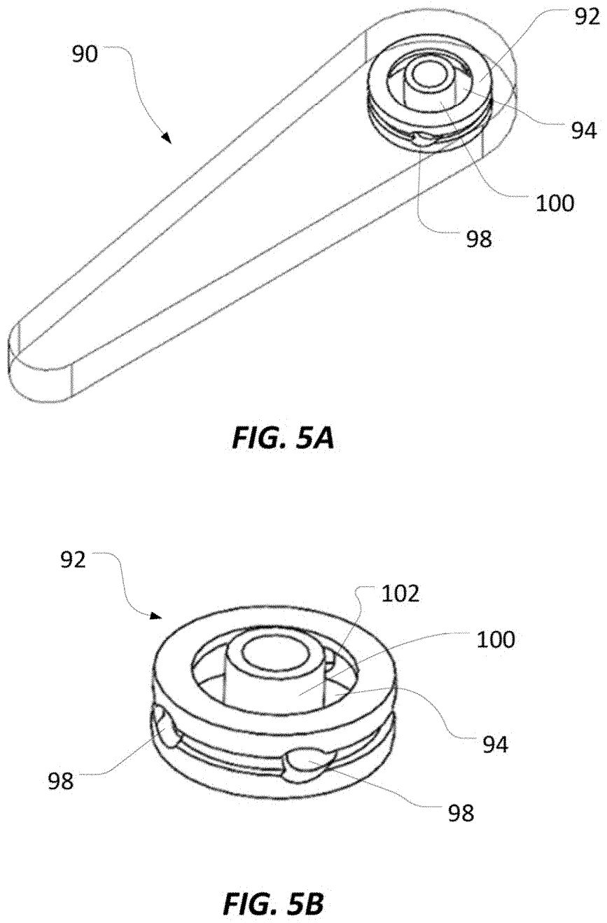

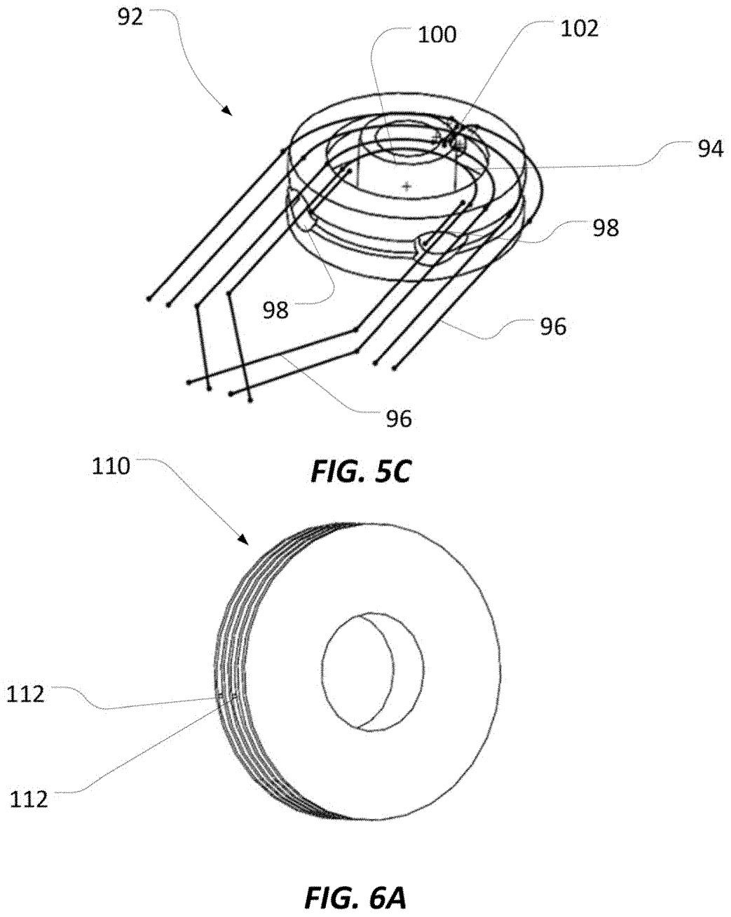

FIG. 5A depicts a part 90 having an insert 92 (FIG. 5B) with an internal cavity 94 which, during co-molding, is filled with flowing fibers 96. As can be seen in FIG. 5C, fibers 96 flow into each cavity 94 from the two holes 98, wrap around the internal boss 100 and flow out of the single hole 102 on the other side of the cavity 94. This configuration helps orient fibers in the hoop direction and allows them to flow back into fibers flowing around the outer diameter of the insert 92. During cooling of the mold, the insert 92 shrinks more than the hoop-oriented fibers and trap them with a compressive force. The undercut on the outer cavity is not necessary, but may help control fiber flow and may support out-of-plane moments. This insert 92 would also support torsional loads by the fibers that flow through the outer ring to bond with fibers outside of the lug.

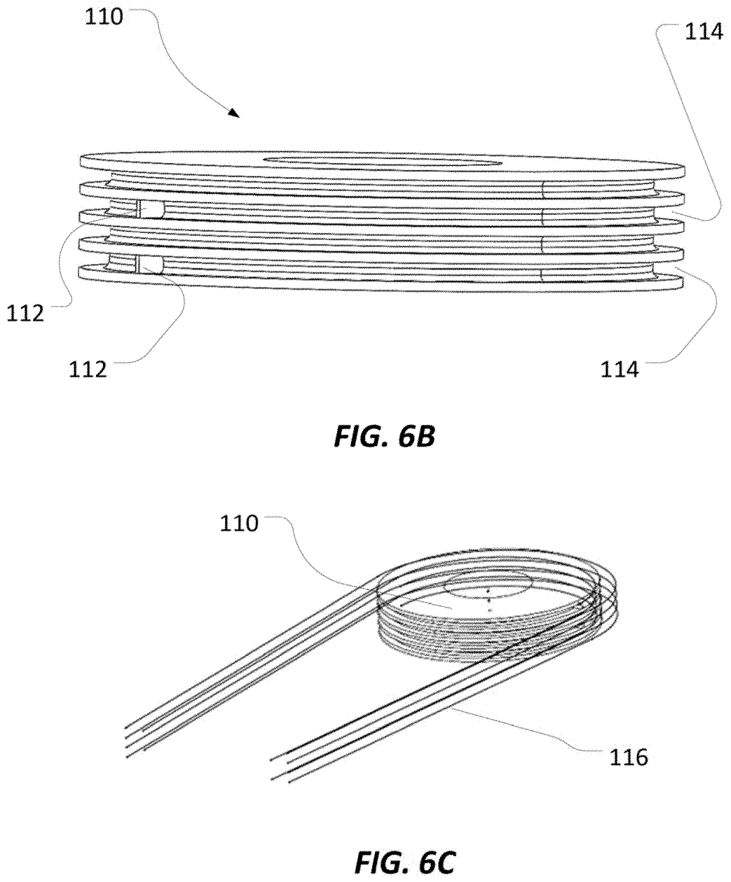

Finally, FIGS. 6A, 6B and 6C depict an insert 110 that promotes the overlap of fibers 102. The insert 110 uses alternating flow dams 112 at, for example, 90 degrees and 270 degrees in grooves 114 to promote overlapping flow segments and prevent a singular “weld” line at the far end of the lug. In this regard, when all fibers 116 are flowed from one end, it is common to create a singular line of entwined fiber ends (i.e., the weld line), resulting in a relatively weak area of discontinuous fibers at the far end of the lug. This embodiment encourages fibers to wrap around the lug 270 degrees instead of 180 degrees by blocking fibers at alternating levels. Overlapping fibers result in much higher hoop strength and better lug retention.

In some other embodiments of the afore-described insert designs, securement features on one insert design can be combined with securement features on another lug design. For example, the CTE-based fiber trapping of the lug of FIGS. 3A, 3B and 3C and the alternating flow dam of the lug of FIGS. 6A, 6B and 6C could both be used in a single insert. Other combinations of the approaches disclosed within are possible and are within the capabilities of those skilled in the art in light of the present disclosure.

What is claimed:

1. A compression molding method for fabricating a fiber composite part having at least one insert, the method utilizing a female mold, the method comprising:
(a) disposing an assemblage of preforms in the mold, each preform comprising plural, co-aligned, resin-impregnated fibers,
(b) placing the at least one insert in the mold adjacent to at least one of the preforms, wherein each insert comprises a plurality of securement features formed therein, the securement features for receiving a portion of the co-aligned resin-impregnated fibers from at least one preform; and
(c) applying heat and pressure in an amount sufficient to consolidate the resin-impregnated fibers into a resin matrix, thereby forming the fiber-composite part, including consolidating the fibers and resin within the securement features of the at least one insert;
whereby the at least one insert is secured in the part by the co-aligned resin-impregnated fibers within the securement features of the insert.

2. The molding method of claim 1, wherein the step of disposing an assemblage of preforms includes disposing preforms having fibers aligned with anticipated in-use stress vectors in the fiber composite part.

3. The molding method of claim 1, wherein the step of applying heat and pressure including consolidating fibers and resin within the securement features includes flowing of fibers and resin into the securement feature.

4. The molding method of claim 1, wherein the step of applying heat and pressure including consolidating fibers and resin within the security features includes capturing fibers and resin within the securement feature.

5. The molding method of claim 1, wherein the step of applying heat and pressure including consolidating fibers and resin within the securement features includes flowing of fibers and resin into the securement feature and capturing fibers and resin with the securement feature.

6. The molding method of claim 1, wherein the step of placing the insert includes placing an insert having at least one securement feature that is a cavity.

7. The molding method of claim 1, wherein the step of placing the insert comprises placing the insert having securement features with a plurality of micro-orifices, each micro-orifice to receive at least one fiber, and wherein the step of applying heat and pressure comprises flowing the at least one fiber into each micro-orifice.

8. The molding method of claim 7, wherein the micro-orifices have a diameter of at least an order of magnitude greater in size than the fibers.

9. The molding method of claim 1, wherein the securement feature includes features selected from the group consisting of baffles, helices, cavities, holes, protuberances and channels.

10. The molding method of claim 1, wherein the at least one insert has a different coefficient of thermal expansion than that of the resin-impregnated fibers, and wherein the step of applying heat and pressure causes the resin-impregnated fibers to expand and contract at a different rate than the insert.

11. The molding method of claim 1, wherein the resin comprises thermoplastic.

12. The molding method of claim 1, wherein the insert is constructed from a non-composite-material.

13. The molding method of claim 12, wherein the non-composite material is selected from the group consisting of metal, ceramic, or another resin or composite having a higher melt temperature than that of the resin.

14. The molding method of claim 1, wherein the at least one insert comprises a fastener or a portion thereof.

15. The molding method of claim 14, wherein the fastener is a threaded fastener or a portion thereof.

16. A fiber composite part, comprising:
(a) a first plurality of continuous, co-aligned fibers within a resin matrix, and
(b) at least one insert disposed in the resin matrix, the insert comprising at least one securement feature having a second plurality of the fibers therein, the second plurality of fibers extending into the resin matrix and overlapping with some of the first plurality of fibers.

17. The composite part of claim 16, wherein at least one of the securement features comprises at least one macro security feature of a similar size to a diameter of towpreg used in the fabrication of the part.

18. The composite part of claim 17, comprising a plurality of micro security features in at least one of the macro security features, the micro security features to receive the second plurality of fibers.

19. The composite part of claim 16, wherein at least one of the securement features includes at least one vent.

20. The composite part of claim 16, wherein the securement features include features selected from the group consisting of baffles, helices, cavities, holes, and channels.

21. The composite part of claim 16, wherein the at least one insert has a different coefficient of thermal expansion that that of the resin matrix and the first plurality of fibers.

22. The composite part of claim 16, wherein the resin comprises thermoplastic.

23. The composite part of claim 16, wherein the insert is constructed from a non-composite-material.

24. The composite part of claim 23, wherein the non-composite material is selected from the group consisting of metal, ceramic, and another resin or composite having a higher melt temperature than that of the resin.

25. The composite part of claim 16, wherein at least one of the inserts is a fastener or a portion thereof.

26. The composite part of claim 16, wherein the at least one insert comprises a threaded fastener or a portion thereof.

27. The composite part of claim 16, wherein the at least one securement feature aligns with a proximate, anticipated principal stress vector in the fiber composite part.
